(19) United States
(12) Patent Application Publication
(10) Pub. No.: US 2013/0117525 A1
(43) Pub. Date: May 9, 2013

(54) METHOD FOR IMPLEMENTING PRE-EMPTIVE READ RECONSTRUCTION

(71) Applicants: Martin Jess, Erie, CO (US); Kevin Kidney, Lafayette, CO (US); Richard E. Parker, Berthoud, CO (US); Theresa L. Segura, Broomfield, CO (US)

(72) Inventors: Martin Jess, Erie, CO (US); Kevin Kidney, Lafayette, CO (US); Richard E. Parker, Berthoud, CO (US); Theresa L. Segura, Broomfield, CO (US)

(73) Assignee: LSI CORPORATION, Milpitas, CA (US)

(21) Appl. No.: 13/289,677

(22) Filed: Nov. 4, 2011

(51) Int. Cl. G06F 12/00

(52) U.S. Cl. 711/171; 711/E12.001

(57) ABSTRACT

The present invention is directed to a method for pre-emptive read reconstruction. In the method(s) disclosed herein, when a pre-emptive read reconstruction timer times out, if one or more drive read operations for providing requested stripe read data are still pending; and if stripe read data corresponding to the pending drive read operations may be constructed (ex.—reconstructed) based on the stripe read data received before the expiration of the timer, the pending drive read operations are classified as stale, but the pending drive read operations are still allowed to complete rather than being aborted, thereby promoting efficiency of the data storage system in situations when the data storage system includes an abnormal disk drive (ex.—a disk drive which endures random cycles of low read performance).

### FIELD OF THE INVENTION

The present invention relates to the field of data management via data storage systems and particularly to a method for implementing pre-emptive read reconstruction.

### BACKGROUND OF THE INVENTION

Currently available methods for providing data management in data storage systems may not provide a desired level of performance.

Therefore, it may be desirable to provide a method(s) for providing data management in a data storage system which addresses the above-referenced shortcomings of currently available solutions.

### SUMMARY OF THE INVENTION

Accordingly, an embodiment of the present invention is directed to a method for implementing pre-emptive read reconstruction (ex.—construction) via a storage controller in a data storage system, the method including: receiving a read request for stripe data stored in a drive pool of the data storage system, the read request being received from a host system; based upon the read request, providing a plurality of read commands to a plurality of disk drives of the drive pool to initiate a plurality of drive read operations for obtaining the requested stripe data from the drive pool; starting a timer, the timer being programmed to run for a pre-determined time interval; allocating a plurality of buffers of the storage controller cache, the buffers being allocated for the requested stripe data; when the pre-determined time interval expires, and a first portion of the stripe data has been received by the storage controller, and a second portion of the stripe data has not been received by the storage controller, determining if a copy of the second portion of the stripe data can be constructed from the received first portion of the stripe data; when the storage controller determines that the copy of the second portion can be constructed from the received first portion: constructing the copy of the second portion; providing the first portion and the constructed second portion to the host system; and classifying an outstanding drive read operation corresponding to the second portion of the data as stale; receiving the second portion of stripe data; verifying that the received second portion of stripe data corresponds to the stale drive read operation; and when verifying indicates that the received second portion of stripe data corresponds to the stale drive read operation, de-allocating a buffer included in the plurality of buffers, said de-allocated buffer having been previously allocated for the second portion of the stripe data.

A further embodiment of the present invention is directed to a computer program product comprising: a signal bearing medium bearing: computer-usable code configured for receiving a read request for stripe data stored in a drive pool of the data storage system, the read request being received from a host system; computer-usable code configured for, based upon the read request, providing a plurality of read commands to a plurality of disk drives of the drive pool to initiate a plurality of drive read operations for obtaining the requested stripe data from the drive pool; computer-usable code configured for starting a timer, the timer being programmed to run for a pre-determined time interval; computer-usable code configured for allocating a plurality of buffers of the storage controller cache, the buffers being allocated for the requested stripe data; computer-usable code configured for, when the pre-determined time interval expires, and a first portion of the stripe data has been received by the storage controller, and a second portion of the stripe data has not been received by the storage controller, determining if a copy of the second portion of the stripe data can be constructed from the received first portion of the stripe data; computer-usable code configured for, when the storage controller determines that the copy of the second portion can be constructed from the received first portion: constructing the copy of the second portion; providing the first portion and the constructed second portion to the host system; and classifying an outstanding drive read operation corresponding to the second portion of the data as stale; computer-usable code configured for receiving the second portion of stripe data; computer-usable code configured for verifying that the received second portion of stripe data corresponds to the stale drive read operation; and computer-usable code configured for, when verifying indicates that the received second portion of stripe data corresponds to the stale drive read operation, de-allocating a buffer included in the plurality of buffers, said de-allocated buffer having been previously allocated for the second portion of the stripe data.

A still further embodiment of the present invention is directed to a method for implementing pre-emptive read reconstruction via a storage controller in a data storage system, the method including: receiving a read request for data stored in a drive pool of the data storage system, the read request being received from a host system; based upon the read request, providing a plurality of read commands to a plurality of disk drives of the drive pool to initiate a plurality of drive read operations for obtaining the requested data from the drive pool; starting a timer, the timer being programmed to run for a pre-determined time interval; allocating a plurality of buffers of the storage controller cache, the buffers being allocated for the requested data; when the pre-determined time interval expires, and a first portion of the data has been received by the storage controller, and a second portion of the data has not been received by the storage controller, determining if a copy of the second portion of the data can be constructed from the received first portion of the data; when the storage controller determines that the copy of the second portion can be constructed from the received first portion: constructing the copy of the second portion; providing the first portion and the constructed second portion to the host system; and when the storage controller determines that the copy of the second portion cannot be constructed from the received first portion: issuing additional read commands from the storage controller to the plurality of disk drives for obtaining the requested data to perform the construction.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figure(s) in which:

FIG. 1 is a block diagram schematic illustrating a drive group in accordance with an exemplary embodiment of the present disclosure;

FIG. 2 is a block diagram schematic illustrating a Redundant Array of Inexpensive Disks (RAID) system, which may include a plurality of RAID volumes (and a plurality of volume stripes) stored across a plurality of drives of a drive group in accordance with a further exemplary embodiment of the present disclosure;

FIG. 3 is a block diagram schematic illustrating a data storage system in accordance with an exemplary embodiment of the present disclosure; and

FIG. 4 depicts a flow chart illustrating a method for implementing pre-emptive read reconstruction via a storage controller in a data storage system in accordance with a further exemplary embodiment of the present invention.

### DETAILED DESCRIPTION OF THE INVENTION

Reference will now be made in detail to the presently preferred embodiments of the invention, examples of which are illustrated in the accompanying drawings.

A drive group is a collection of disk drives (ex.—physical drives) used for storing data of a Redundant Array of Inexpensive Disks (RAID) volume. The drive group may be assigned a RAID level, which may define a data organization and a redundancy model of the drive group. The RAID volume may be a host-accessible logical unit target for data input(s)/output(s) (I/Os). The drive group may contain multiple RAID volumes. All volumes (ex.—RAID volumes) within the drive group may use the same set of physical drives and function at the same RAID level.

Drives of the drive group may have different capacities. A usable capacity of the volume group (ex.—group of drives of the drive group upon which a volume is stored) is the RAID factor capacity based on the smallest drive in the group, excluding the region reserved for storage array configuration data. The free capacity of a drive group is the usable capacity minus the capacity of any defined volumes. Free drive group capacity may be used to create additional volumes or expand the capacity of the existing volumes.

The RAID volume may occupy a region on each drive in the drive group. The regions for the RAID volume may all have the same offset (in Logical Block Addresses (LBAs)) from the beginning of the drive and may all have the same length (in LBAs). Each such region that is part of the volume may be referred to as a piece. The collection of pieces for the volume may be referred to as a volume extent. A drive group may also have one or several free extents, each of the free extent(s) may consist of regions of unused capacity on the drive, and each may have the same offset and length.

The number of physical drives in a drive group is referred to as the drive group width. The drive group width affects both performance and accessibility for the RAID volumes in the drive group. The wider the drive group, the more physical spindles that can be deployed in parallel, thereby increasing performance for certain host I/O profiles. However, the wider the drive group, the higher the risk that one of the physical drives of the drive group will fail.

Segment size may be an amount of data that a controller writes to a single drive of the volume group before writing data to the next drive of the volume group. A stripe may be a collection of segments. The collection of segments may include one segment from each drive of the drive group, all with a same offset from the beginning of their drives. Thus, a volume may also be viewed as a collection of stripes.

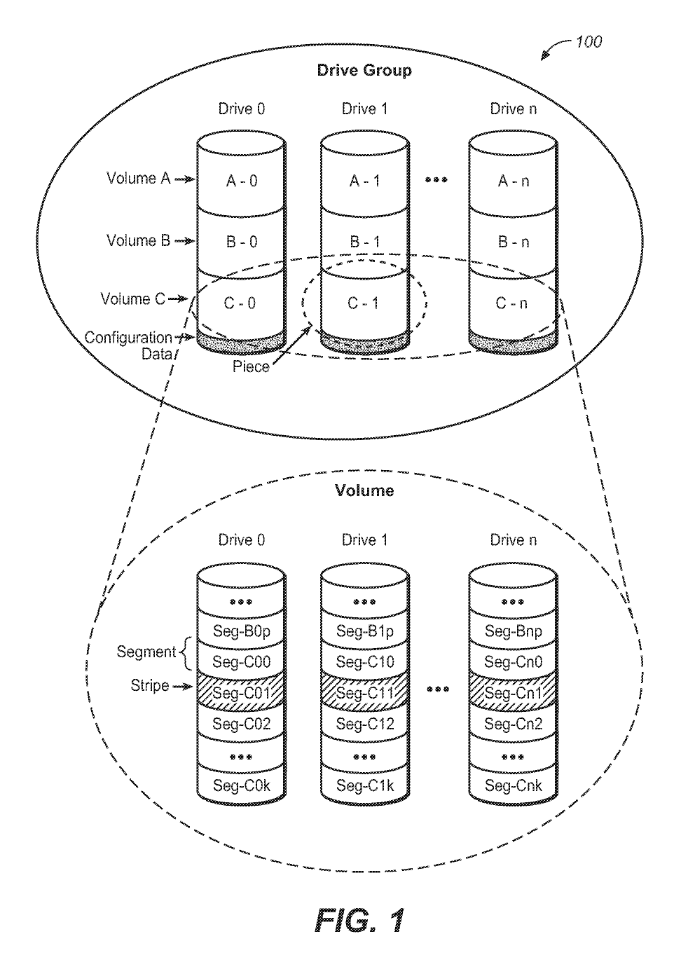

Referring to FIG. 1, a drive group is shown, in accordance with an exemplary embodiment of the present disclosure. The drive group 100 may include a plurality of (ex.—n+1) drives, as shown. The drive group 100 may further store a plurality of volumes (ex.—the volumes being designated as “Volume A”, “Volume B”, “Volume C”, as shown in FIG. 1). A first volume (ex.—“Volume C”) stored on the drive group may include a plurality of (ex.—n+1) pieces (ex.—the pieces being designated as “C-0”, “C-1”, “C-n”). Each piece may contain/include a plurality of segments (the segments being designated as “Seg-C00”, “Seg-C01”, “Seg-C02” “Seg-C0k”, etc., as shown in FIG. 1). In exemplary embodiments, a stripe may be stored across the drive group. For instance, the stripe may be formed by (ex.—may include) a plurality of segments (the segments being designated as “Seg-C01”, “Seg-C11” and “Seg-Cn1”, as shown in FIG. 1). Further, the first volume (ex.—“Volume C”) may include a plurality of (ex.—k+1) stripes.

The drive group 100 (ex.—RAID layout) shown in FIG. 1 may be algorithmic in the sense that a simple calculation may be involved to determine which physical drive LBA on which drive of the drive group 100 corresponds to a specific RAID volume virtual LBA. The RAID volumes may be tightly coupled with the drive group 100 as the width of the drive group 100 may define the width of the RAID volumes, same for the RAID level.

More recent RAID layouts (ex.—RAID volumes on a drive group) may maintain the segment and stripe concepts, but different stripes may be on different drive sets and offsets may vary per segment. These more recent RAID layouts may have much lower reconstruction times when a drive fails, and may also have better load balancing among the drives as well. However, with these more recent (ex.—looser) RAID layouts, the concept of volume stripe reads and writes may still apply, since these more recent RAID layouts may still write in segments, and since there is still a notion of a width (ex.—number of drives in a stripe).

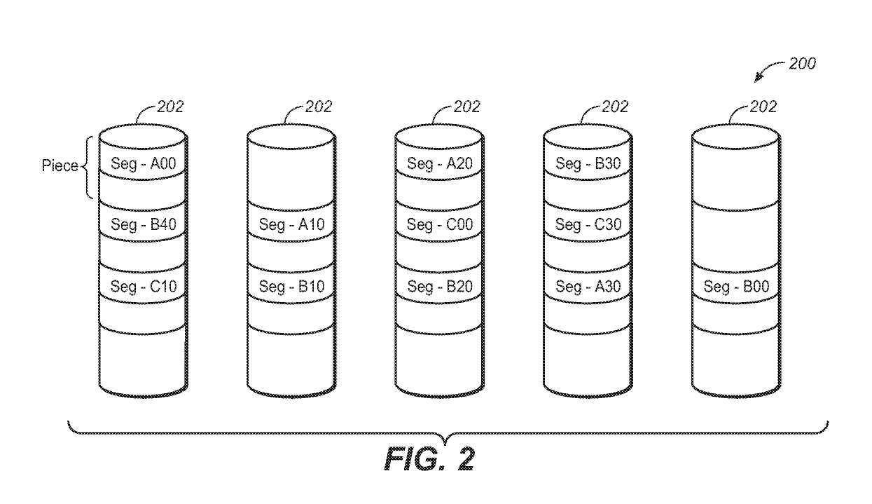

FIG. 2 illustrates an exemplary one of the aforementioned recent RAID layouts, which may include a plurality of RAID volumes (and a plurality of volume stripes) stored across a plurality of drives 202 of a drive group 200. In the illustrated drive group 200, a first volume stripe stored across the drive group 200 may include a first plurality of (ex.—four) segments (ex.—the segments being designated in FIG. 2 as “Seg-A00”, “Seg-A10”, “Seg-A20” and “Seg-A30”) stored across multiple (ex.—four) drives of the drive group 200, thereby giving the first volume stripe a width equal to four. Further, a second volume stripe stored across the drive group 200 may include a second plurality of (ex.—five) segments (ex.—the segments being designated in FIG. 2 as “Seg-B00”, “Seg-B10”, “Seg-B20”, “Seg-B30” and “Seg-B40”) stored across multiple (ex.—five) drives of the drive group 200, thereby giving the second volume stripe a width equal to five. Still further, a third volume stripe stored across the drive group 200 may include a third plurality of (ex.—three) segments (ex.—the segments being designated in FIG. 2 as “Seg-C00”, “Seg-C10” and “Seg-C20”) stored across multiple (ex.—three) drives of the drive group 200, thereby giving the third volume stripe a width equal to three. Further, in the drive group 200 shown in FIG. 2, a single drive may contain multiple pieces of a same volume. Still further, the RAID layout (ex.—drive group; RAID organization) shown in FIG. 2 is not algorithmic and may require a mapping between volume LBAs and individual pieces. In the present disclosure, the generic term drive pool may be used to denote both the traditional drive group concept with the fixed piece and drive organization (as shown in FIG. 1) and the more recent dynamic RAID organization (shown in FIG. 2), which still includes segments and stripes, but eliminates the fixed piece offsets and drive association.

Sometimes, a physical drive within a storage system (ex.—within a drive pool of a storage system) may suddenly exhibit significantly lower read performance than other drives of the exact same model and manufacturer in the same storage system, but without actually failing. Further, this may not even be a persistent condition, but rather, a transient condition, where the read performance becomes very low for random periods of time but then returns to normal. In the present disclosure, the term abnormal drive may be used to refer to a drive exhibiting these random periods of significantly lower read performance. An abnormal drive may significantly affect overall read performance for any read operation that includes that drive. For example, a stripe read from a volume in a RAID drive pool which includes the abnormal drive may take as long as the read from the slowest physical drive in the drive group. Thus, a single abnormal drive in the storage array may significantly slow down stripe reads that include the abnormal drive. In some environments, such as media streaming, video processing, etc., this may cause significant issues, such as when long running operations have to be re-run. In extreme scenarios, the long running operations may take days or weeks to be re-run.

Existing solutions for dealing with the above-referenced abnormal drive read performance issues include starting a timer when a stripe read operation is started. If the timer expires before the stripe read operation has completed, but after enough data has been read into the cache to reconstruct the missing stripe data (ex. using RAID 5 parity), the missing data may be reconstructed and returned to a host/initiator. Further, the outstanding physical drive read operations may be aborted. However, one problem that can arise when aborting the outstanding physical drive read operations is that it may limit how low a timeout value for the timer may be set, since there may be additional timers and timeouts in the I/O path which may come into play (ex.—I/O controller timeout; command aging in the physical drives, etc. Thus, such existing solutions may lead to various race conditions in a back-end drive fabric of the system. Further, by aborting (ex.—attempting to abort) read operations in a drive that is already exhibiting abnormal behavior, the problem may become worse such that any subsequent reads involving the abnormal drive may be slowed even further.

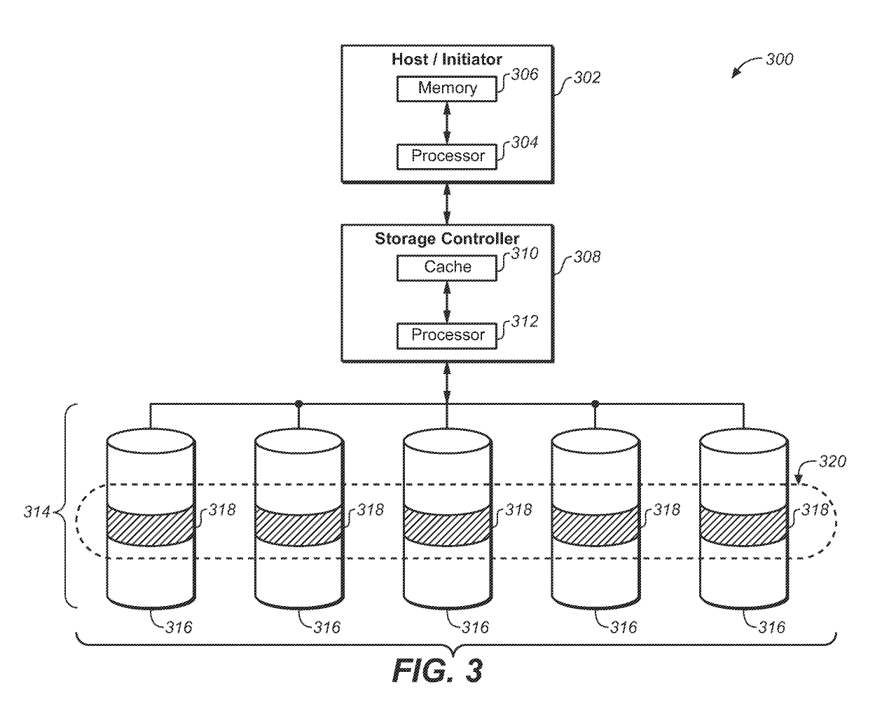

Referring to FIG. 3, a data storage system (ex.—external, internal/Direct-attached storage (DAS), RAID, software, enclosure, network-attached storage (NAS), Storage area network (SAN) system/network) in accordance with an exemplary embodiment of the present disclosure is shown. In exemplary embodiments, the data storage system 300 may include a host computer system (ex.—a host system; a host; a network host) 302. The host computer system 302 may include a processing unit (ex.—processor) 304 and a memory 306, the memory 306 being connected to the processing unit 304. In further embodiments, the system 300 may include one or more controllers (ex.—storage controller(s); disk array controller(s); Redundant Array of Independent Disks (RAID) controller(s); Communication Streaming Architecture (CSA) controllers; adapters). For instance, in an exemplary embodiment shown in FIG. 3, the data storage system 300 includes a single storage controller 308 communicatively coupled with the host 302.

In exemplary embodiments of the present disclosure, the storage controller 308 may include a memory (ex.—controller cache; cache memory; cache) 310. The cache 310 of the storage controller 308 may include a plurality of buffers. The storage controller 308 may further include a processing unit (ex.—processor) 312, the processing unit 312 being connected to the cache memory 310. In further embodiments, the data storage system 300 may further include a storage subsystem (ex.—a drive pool) 314, the drive pool including a plurality of physical disk drives (ex.—hard disk drives (HDDs)) 316. The drive pool 314 may be connected to (ex.—communicatively coupled with) the storage controller 308. Further, the drive pool 314 may be configured for storing RAID volume data, and may be established in or configured as one of a number of various RAID levels or configurations, such as a RAID 3 configuration (ex.—RAID 3 level), a RAID 5 configuration (ex.—a RAID 5 level; RAID 5 parity) or a RAID 6 configuration (ex.—a RAID 6 level; RAID 6 parity).

As mentioned above, the drive pool 314 of the system 300 may be configured for storing RAID volume data. Further, as mentioned above, RAID volume data may be stored as segments 318 across the drive pool 314. For instance, as shown in the illustrated embodiment in FIG. 3, each drive 316 may store segment(s) 318 of the RAID volume data, the segments 318 collectively forming a stripe 320.

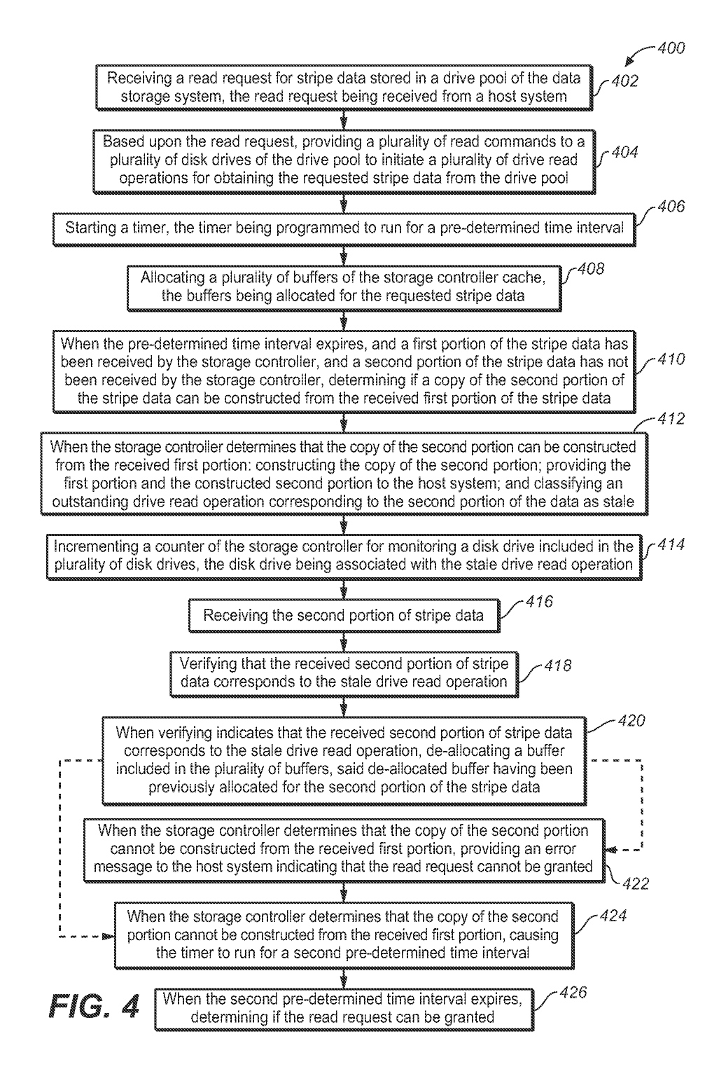

In FIG. 4, a flowchart is provided which illustrates a method for implementing pre-emptive read reconstruction via a storage controller in a data storage system (ex.—such as the system 300, shown in FIG. 3) in accordance with an exemplary embodiment of the present disclosure. The method 400 may include the step of receiving an I/O request (ex.—a read request) for stripe data stored in a drive pool of the data storage system, the read request being generated by and/or received from an initiator (ex.—host system) 402. For example, as shown in FIG. 3, the request may be received by the storage controller 308 and the stripe data (ex.—stripe) 320 may include a plurality of segments 318 stored across a plurality of physical disk drives 316 of the drive pool 314.

The method 400 may further include the step of, based upon the read request, providing (ex.—transmitting) a plurality of read commands to a plurality of disk drives of the drive pool to initiate a plurality of drive read operations for obtaining the requested stripe data from the drive pool 404. For instance, the storage controller 308, in response to receiving the host read request, may transmit a plurality of read commands, the plurality of read commands collectively requesting all of the stripe data which was initially requested by the host 302. For example, for the exemplary drive pool 314 shown in FIG. 3, a first read command may be directed to a first disk drive included in the drive pool 314 for initiating a first drive read operation to obtain a first segment (designated as “Seg-1” in FIG. 3) of the host-requested stripe data; a second read command may be directed to a second disk drive included in the drive pool 314 for initiating a second drive read operation to obtain a second segment (designated as “Seg-2” in FIG. 3) of the host-requested stripe data; a third read command may be directed to a third disk drive included in the drive pool 314 for initiating a third drive read operation to obtain a third segment (designated as “Seg-3” in FIG. 3) of the host-requested stripe data; a fourth read command may be directed to a fourth disk drive included in the drive pool 314 for initiating a fourth drive read operation to obtain a fourth segment (designated as “Seg-4” in FIG. 3) of the host-requested stripe data; a fifth read command may be directed to a fifth disk drive included in the drive pool 314 for initiating a fifth drive read operation to obtain a fifth segment (designated as “Seg-5” in FIG. 3) of the host-requested stripe data. The plurality of drive read operations may collectively form or be referred to as a stripe read operation.

The method 400 may further include the step of starting (ex.—activating) a timer, the timer being set (ex.—programmed; pre-programmed) to run for a pre-determined time interval 406. For example, when the storage controller 308 provides the read commands to the drive pool 314, the storage controller 308 may start/activate a timer (ex.—a pre-emptive read reconstruction timer). The timer may be configured and/or allowed by the storage controller 308 to run for a non-zero, finite duration of time (ex.—a time interval; a pre-determined time interval) before/until the time interval expires, at which point, the timer may time-out (ex.—stop running) Further, activation of the timer may coincide with (ex.—occur at the same time as) commencement of the drive read operations (ex.—the transmitting of the read commands to the drive pool).

The method 400 may further include the step of allocating a plurality of buffers of the storage controller cache, the buffers being allocated for the requested stripe data 408. For example, buffers of the storage controller cache 310 may be allocated and locked in preparation for receiving the requested stripe data which is to be provided by the drive read operations.

The method 400 may further include the step of, when the pre-determined time interval expires, and a first portion of the stripe data has been received by the storage controller, and a second portion of the stripe data has not been received by the storage controller, determining if a copy of the second portion of the stripe data can be constructed from the received first portion of the stripe data 410. For instance, the time interval may expire before all of the drive read operations are completed (ex.—before the stripe read operation is complete; before all of the requested stripe read data has been obtained by the storage controller). In such event, the storage controller 308 may have received some of the requested stripe data, but, because some of the drive read operations may not yet have completed (ex.—due to one or more of the drives of the drive pool being an abnormal drive and exhibiting lower read performance than the drives of the drive pool which were able to complete their drive read operations within), the rest of the requested stripe data may not yet have been received (ex.—may be missing). As a result, the storage controller 308 may determine if the missing stripe data can be reconstructed (ex.—using RAID 5 parity) using the stripe read data which has been received by (ex.—read into the cache of) the storage controller 308.

The method 400 may further include the step of when the storage controller determines that the copy of the second portion can be constructed from the received first portion: constructing the copy of the second portion; providing the first portion and the constructed (ex.—reconstructed) second portion to the host system; and classifying an outstanding drive read operation corresponding to the second portion of the data as stale 412. For instance, if the storage controller 308 determines that it can reconstruct the missing stripe data based on the already-received stripe data, the missing stripe read data is reconstructed and the already-received stripe data and reconstructed stripe data are sent to the host/initiator 302. Further, the outstanding drive read operations (ex.—the drive read operations which did not return requested stripe read data within the pre-determined time interval) are classified by the storage controller 308 as stale, however, no attempt is made to abort these outstanding drive read operations, they are allowed to continue trying to complete. Further, buffers of the storage controller cache 310 which are allocated and locked for receiving stripe data associated with the outstanding drive read operations may remain allocated and locked in preparation for receiving that stripe data until those outstanding drive read operations complete (ex.—succeed or fail). Provision of the stripe data 320 to the buffers of the storage controller cache 310 via the drive read operations may involve: Direct Memory Access (DMA) operations from the physical drives 316 to the storage controller cache 310 to place the requested stripe read data in the allocated buffers; and then sending a notifications (interrupts) from the physical drives 316 to the storage controller (ex.—to software of the storage controller) 308 indicating that the drive read operations have completed.

In exemplary embodiments, the method 400 may further include the step of incrementing a counter of the storage controller for monitoring a disk drive included in the plurality of disk drives, the disk drive being associated with the stale drive read operation 414. For example, when the pre-emptive read reconstruction timer runs for its pre-determined time interval and then times-out, a counter may be incremented by the storage controller 308 for each drive 316 of the drive pool 314 that still has a drive read operation pending. This allows the system 300 a way to keep track of drives 316 which do not respond within the time interval. If the storage controller has to increment the counter an unusually high number of times for a particular physical drive, a user of the system 300 may choose to power cycle or replace that physical drive.

The method 400 may further include the step of receiving the second portion of stripe data 416. For example, at some point after the timer's time interval expires, the outstanding drive read operation(s) (ex.—stale drive read operations) may complete and provide the missing stripe data to the storage controller. Any buffers of the storage controller cache 310 which were allocated and locked for this missing stripe data may receive it.

The method 400 may further include the step of verifying that the received second portion of stripe data corresponds to the stale drive read operation 418. For instance, when the storage controller 308 receives the remaining stripe read data via the outstanding (ex.—stale) drive read operations, the storage controller verifies (ex.—checks; confirms) that the remaining stripe data corresponds to (ex.—was provided via) stale drive read operation(s).

The method 400 may further include the step of, when verifying indicates that the received second portion of stripe data corresponds to the stale drive read operation, de-allocating a buffer included in the plurality of buffers, said de-allocated buffer having been previously allocated for the second portion of the stripe data 420. For example, once the storage controller 308 verifies that the received missing stripe data was provided via drive read operations which the controller classified as being stale, the controller 308 may de-allocate (ex.—free; unlock) its cache buffers which were allocated to the second portion of the stripe data and allow those buffers to then be used for other I/O operations. Further, if the stripe data was received via completion of the last outstanding drive read operation of the stripe read operation, the storage controller 308 may also free a parent buffer data structure of the cache 310 which may have been allocated for the overall stripe read operation. In alternative embodiments, once the outstanding read has been marked stale, rather than performing the above-described verifying steps (418 and 420), the completed drive read operation's attributes may be examined and if that completed drive read operation is stale, the buffers allocated to that drive read may be freed up.

As mentioned above, with step 410, the method 400 may include the step of determining if a copy of the second portion of the stripe data can be constructed from the received first portion of the stripe data. The above-described step 412 indicates what may occur when it is determined that a copy of the second portion of the stripe data can be constructed from the received first portion of the stripe data. However, the method 400 may include the step of, when the storage controller determines that the copy of the second portion cannot be constructed (ex.—reconstructed) from the received first portion, providing an error message to the host system indicating that the read request cannot be granted 422. For instance, the error message may be returned by the storage controller 308 to the host 302 even when it may not be known for certain yet whether the stripe read operation would fail or not. For some applications, this may be a better option for promoting system efficiency rather than continuing to let the read wait. Alternatively, the method 400 may include the steps of: when the storage controller determines that the copy of the second portion cannot be constructed from the received first portion, causing the timer to run for a second pre-determined time interval 424; and when the second pre-determined time interval expires, determining if the read request can be granted 426. For example, the pre-emptive read reconstruction timer may be restarted and may run for some second (ex.—new) pre-determined time interval (ex.—time-out value) and the above-described process may be repeated in an attempt to obtain enough completed drive read operations to allow for granting of the host read request to be completed.

Further, with the method(s) of the present disclosure, if a drive read operation that was classified as stale fails, the storage controller 308 does not go through retry logic for the drive read operation (ex.—drive read), rather, the controller 308 just fails the drive read operation immediately. Also, if the stripe read data corresponding to the stale drive read operation(s) was already reconstructed and returned to the host 302 when the pre-emptive read construction timer expired, there is none of the normal reconstruction of the missing data when the drive read operation is actually considered failed.

The higher the RAID redundancy level of the system 300 (ex.—of the drive pool 314), the more resilient the system 300 is to abnormal drives. For instance, with RAID 6, up to two slow drives may be tolerated in the same stripe without affecting stripe read performance. With RAID 3 or 5, only one slow drive in the same stripe may be tolerated.

It is important to set the pre-emptive read reconstruction timer so that a normal drive can complete the requested drive read operations within the time-out interval. When the timer expires, there should be enough data in the cache 310 to reconstruct any missing read data, otherwise there is no benefit to the pre-emptive read reconstruction timer.

An advantage to the method(s) of the present disclosure is the pre-emptive read reconstruction timer time interval can be set much lower than in cases where outstanding drive read operations are aborted. This provides a more predictable stripe read performance which is very important for media streaming applications such as video/film production and broadcast.

In further embodiments, it is contemplated by the present disclosure that the host read request received by the storage controller 308 may be a full stripe read or less than a full stripe read. In embodiments in which the host read is for less than a full stripe of data, and the first portion of the requested data received by the storage controller 308 from the drives 316 is not enough to reconstruct the second portion of the requested data, the storage controller 308 may issue additional read commands (ex.—drive reads) to the drives 316 in order to get enough data into the controller cache 310 to allow the storage controller 308 to reconstruct the second portion (ex.—the missing or delayed data).

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium/computer-readable storage medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for implementing pre-emptive read reconstruction via a storage controller in a data storage system, the method comprising:
receiving a read request for stripe data stored in a drive pool of the data storage system, the read request being received from a host system;
based upon the read request, providing a plurality of read commands to a plurality of disk drives of the drive pool to initiate a plurality of drive read operations for obtaining the requested stripe data from the drive pool;
starting a timer, the timer being programmed to run for a pre-determined time interval;
allocating a plurality of buffers of the storage controller cache, the buffers being allocated for the requested stripe data;
when the pre-determined time interval expires, and a first portion of the stripe data has been received by the storage controller, and a second portion of the stripe data has not been received by the storage controller, determining if a copy of the second portion of the stripe data can be constructed from the received first portion of the stripe data; and
when the storage controller determines that the copy of the second portion can be constructed from the received first portion: constructing the copy of the second portion; providing the first portion and the constructed second portion to the host system; and classifying an outstanding drive read operation corresponding to the second portion of the data as stale.

2. A method as claimed in claim 1, further comprising:
incrementing a counter of the storage controller for monitoring a disk drive included in the plurality of disk drives, the disk drive being associated with the stale drive read operation.

3. A method as claimed in claim 1, further comprising:
receiving the second portion of stripe data.

4. A method as claimed in claim 3, further comprising:
verifying that the received second portion of stripe data corresponds to the stale drive read operation.

5. A method as claimed in claim 4, further comprising:
when verifying indicates that the received second portion of stripe data corresponds to the stale drive read operation, de-allocating a buffer included in the plurality of buffers, said de-allocated buffer having been previously allocated for the second portion of the stripe data.

6. A method as claimed in claim 1, further comprising:
when the storage controller determines that the copy of the second portion cannot be constructed from the received first portion, providing an error message to the host system indicating that the read request cannot be granted.

7. A method as claimed in claim 1, further comprising:
when the storage controller determines that the copy of the second portion cannot be constructed from the received first portion, causing the timer to run for a second pre-determined time interval.

8. A method as claimed in claim 7, further comprising:
when the second pre-determined time interval expires, determining if the read request can be granted.

9. A computer program product comprising:
a signal bearing medium bearing:
computer-usable code configured for receiving a read request for stripe data stored in a drive pool of the data storage system, the read request being received from a host system;
computer-usable code configured for, based upon the read request, providing a plurality of read commands to a plurality of disk drives of the drive pool to initiate a plurality of drive read operations for obtaining the requested stripe data from the drive pool;
computer-usable code configured for starting a timer, the timer being programmed to run for a pre-determined time interval;
computer-usable code configured for allocating a plurality of buffers of the storage controller cache, the buffers being allocated for the requested stripe data;
computer-usable code configured for, when the pre-determined time interval expires, and a first portion of the stripe data has been received by the storage controller, and a second portion of the stripe data has not been received by the storage controller, determining if a copy of the second portion of the stripe data can be constructed from the received first portion of the stripe data; and
computer-usable code configured for, when the storage controller determines that the copy of the second portion can be constructed from the received first portion: constructing the copy of the second portion; providing the first portion and the constructed second portion to the host system; and classifying an outstanding drive read operation corresponding to the second portion of the data as stale.

10. A computer program product as claimed in claim 9, the signal-bearing medium further bearing:
computer-usable code configured for incrementing a counter of the storage controller for monitoring a disk drive included in the plurality of disk drives, the disk drive being associated with the stale drive read operation.

11. A computer program product as claimed in claim 9, the signal-bearing medium further bearing:
computer-usable code configured for receiving the second portion of stripe data.

12. A computer program product as claimed in claim 11, the signal-bearing medium further bearing:
computer-usable code configured for verifying that the received second portion of stripe data corresponds to the stale drive read operation.

13. A computer program product as claimed in claim 12, the signal-bearing medium further bearing:
computer-usable code configured for, when verifying indicates that the received second portion of stripe data corresponds to the stale drive read operation, de-allocating a buffer included in the plurality of buffers, said de-allocated buffer having been previously allocated for the second portion of the stripe data.

14. A computer program product as claimed in claim 9, the signal-bearing medium further bearing:
computer-usable code configured for, when the storage controller determines that the copy of the second portion cannot be constructed from the received first portion, providing an error message to the host system indicating that the read request cannot be granted.

15. A computer program product as claimed in claim 9, the signal-bearing medium further bearing:
computer-usable code configured for, when the storage controller determines that the copy of the second portion cannot be constructed from the received first portion, causing the timer to run for a second pre-determined time interval.

16. A computer program product as claimed in claim 15, the signal-bearing medium further bearing:
computer-usable code configured for, when the second pre-determined time interval expires, determining if the read request can be granted.

17. A method for implementing pre-emptive read reconstruction via a storage controller in a data storage system, the method comprising:
receiving a read request for data stored in a drive pool of the data storage system, the read request being received from a host system;
based upon the read request, providing a plurality of read commands to a plurality of disk drives of the drive pool to initiate a plurality of drive read operations for obtaining the requested data from the drive pool;
starting a timer, the timer being programmed to run for a pre-determined time interval;
allocating a plurality of buffers of the storage controller cache, the buffers being allocated for the requested data;
when the pre-determined time interval expires, and a first portion of the data has been received by the storage controller, and a second portion of the data has not been received by the storage controller, determining if a copy of the second portion of the data can be constructed from the received first portion of the data; and
when the storage controller determines that the copy of the second portion can be constructed from the received first portion: constructing the copy of the second portion; providing the first portion and the constructed second portion to the host system; and
when the storage controller determines that the copy of the second portion cannot be constructed from the received first portion: issuing additional read commands from the storage controller to the plurality of disk drives for obtaining the requested data to perform the construction.
